(19) United States
(12) Patent Application Publication
(10) Pub. No.: US 2026/0100472 A1
(43) Pub. Date: Apr. 9, 2026

(54) PRESSURE-EQUALIZING DEVICE FOR A HOUSING, A HOUSING HAVING THE PRESSURE-EQUALIZING DEVICE, AND A METHOD FOR PRODUCING THE PRESSURE-EQUALIZING DEVICE

(71) Applicant: Böllhoff Verbindungstechnik GmbH, Bielefeld (DE)

(72) Inventors: Sandra Steffenfauseweh, Verl (DE); Alexander Vorderwisch, Bielefeld (DE)

(21) Appl. No.: 19/113,644

(22) PCT Filed: Aug. 17, 2023
(86) PCT No.: PCT/EP2023/072716

§ 371 Date: Mar. 20, 2025

(30) Foreign Application Priority Data
Sep. 23, 2022 (DE) 10 2022 124 526.8

(51) Int. Cl. H01M 50/308; H01M 50/30

(52) U.S. Cl. CPC H01M 50/308; H01M 50/394

(57) ABSTRACT

A pressure-equalizing device for a housing with a lower part that has a fastening region for fastening to the housing and a connecting region; and an upper part which has a wall and a base, the upper part engaging the connecting region at an end of the lower part. The lower part has a projection defining an opening and having a clamping structure on a side that faces toward the end and also having multiple passages arranged in a ring shape between the opening and the clamping structure. The upper part has a second clamping structure. A membrane covers the opening, and a seal is arranged between the clamping structures and extends with a sealing region radially inward of the opening and seals the passages. A first path runs via the opening and the membrane, and a second path runs via the passages and the resilient seal component.

### 1. TECHNICAL FIELD

The present disclosure is related to a pressure equalizing device for a housing, for example a battery housing, a housing with the pressure equalizing device as well as a method for producing the pressure equalizing device.

### 2. BACKGROUND

Pressure equalizing devices are for example used in drive batteries of electronic vehicles, with the pressure equalizing devices having to fulfil different functionalities. Thus it is on the one hand necessary to realize a continuous ventilation and aeration due to temperature fluctuations during operation. Furthermore, an intermittent aeration must be possible to avoid damages. This functionality plays an important role which may be in case of an accident. Finally, requirements to tightness, electric isolation, protection against misuse and the like are often required criteria. Generally, the expert knows a variety of different embodiments of such pressure equalizing devices for housings from the state of the art.

For example, EP 3 385 584 describes a pressure-equalizing device for a housing, wherein the pressure-equalizing device comprises an inner side, an outer side and a grid-like cage with a gas passage opening. The gas passage opening connects the inner side and the outer side in flow-conducting fashion as required and is delimited in the direction of its throughflow capability by an inner and an outer edge. Furthermore, the gas passage opening is covered by a gas-permeable membrane. The membrane is configured as a nonwoven composite part and comprises at least one nonwoven layer.

DE 11 2019 005 328 T5 explains an alternative ventilation component. Same is to be attached to a housing at a ventilation opening. The ventilation component comprises a gas-permeable membrane, a ventilation valve and a structural member. The structural member has an inner space and a first ventilation path and/or a second ventilation path. The inner space is a space which receives the gas permeable membrane and/or the ventilation valve. The first ventilation path allows the inner space to be connected with an outer space of the ventilation component. The first ventilation path comprises a first inner opening and a first outer opening and the first inner opening is directed to the first outer opening. The first inner opening and the first outer opening are present along a plane parallel to an outer surface of the housing. The second ventilation path has a second inner opening and a second outer opening and the second inner opening is present without being oriented toward the second outer opening.

A further device for pressure equalization is described in DE 10 2017 214 754 A1. In order to provide a device for equalizing an inner pressure of a housing, in particular a battery housing for a vehicle, with an ambient pressure of the housing, which integrates in a component the functions pressure equalization in normal operation and emergency degassing, the device comprises a pressure equalizing element. The pressure equalizing element includes at least one element body and a membrane that is arranged at the element body. The device comprises a connecting element for the airtight connecting of the pressure equalizing element with the housing. The element body has an elasticity due to which in case of an inner pressure that is smaller than a limiting pressure, the element body attaches the connecting element in an airtight manner and in case of an inner pressure that is bigger than the limiting pressure, the element body unveils an opening between the element body and the connecting element for the exchange of gas.

A pressure balancing device having a mounting seat and a cover, wherein an accommodating cavity is formed between the mounting seat and the cover, is discussed in US 2021/0367283 A1. The pressure balancing device may also have a partition member, wherein the partition member divides the accommodating cavity into first and second accommodating cavities. The partition member may also include a support portion and an elastic portion, the support portion being disposed on the elastic portion and having a vent hole capable of fluidly communicating the accommodating cavities. The elastic section is elastically deformable so as to move the support section relative to the cover. The pressure balancing device may also have a breathable film that is disposed on the support portion and covers the vent hole, and that is movable as the support portion moves.

Finally, WO 2018/183804 A1 describes a vent assembly having a housing defining a cavity, a first end, a second end and a coupling structure towards the second end. A mounting surface is positioned between the first end and the second end within the cavity and defines a valve opening and a ventilation opening. A vent is coupled to the mounting surface via the vent opening. Furthermore, an umbrella valve is sealably disposed on the mounting surface via a valve opening.

A disadvantage of these known arrangements is the number of individual components as well as the kind of fastening the element for the emergency aeration. Due to the construction of the known pressure equalizing devices, it is additionally often necessary to provide a positionally correct alignment of the individual parts in the course of the assembly, so that an automated manufacturing process of the pressure equalizing device is made difficult.

It is therefore the object of at least some implementations of the present disclosure to provide an alternative assembly for a pressure equalizing device, which may be optimized with regard to production and assembly, respectively. In the same way, it is an object of at least some implementations of the present disclosure to provide a corresponding manufacturing or assembly method for the pressure equalizing device.

### 3. SUMMARY

The above object is solved by a pressure equalizing device for a housing, a housing with the pressure equalizing device as well as a manufacturing method of a pressure equalizing device. Advantageous embodiments and further developments result from the following description, the drawings as well as the appending claims.

A pressure equalizing device for a housing comprises: a hollow cylindrical bottom part which radially outside includes a fastening portion for being fastened to the housing at a first axial end, and at a second axial end a connecting portion, an upper part having a cylindrical wall and a bottom and engaging the connecting portion at the second axial end of the bottom part, with the hollow cylindrical bottom part having a circumferential protrusion projecting radially to the inside and defining a central passage opening, and on a side facing the second axial end a first, which may be an annular clamping structure, which may be a first annular groove, as well as a plurality of vents that are arranged annularly between the central passage opening and the first clamping structure, and the upper part comprises a second clamping structure projecting in axial direction from the bottom, with the second clamping structure which may be arranged annularly and/or including a second groove and which may extend in axial direction parallel to the cylindrical wall, with a gas permeable membrane covering the central passage opening and an elastic sealing component being arranged with a fastening portion between the first clamping structure of the bottom part and the second clamping structure of the upper part and extending with a sealing portion radially to the inside in the direction of the central passage opening and seals the plurality of vents, so that a ventilation and aeration path extends via the central passage opening and the gas permeable membrane and an emergency aeration path extends via the plurality of vents and the elastic sealing component.

Hereinafter, the pressure equalizing device is at first described on the basis of the assembly and subsequently when being used in a housing, in particular a battery housing, as for example a multi-power battery for an electric vehicle.

The pressure equalizing device includes four elements, namely the bottom part, the upper part or the cover, the gas permeable membrane, which is arranged in the ventilation and aeration path, as well as the elastic sealing component which in case of need gives way to the emergency aeration path.

The bottom part is configured hollow-cylindrically and comprises, in the known manner, a fastening portion at the first axial end for the fastening to the housing, in particular for the fastening in an opening of the housing. For example, an inner thread is provided in the opening of the housing. In this case, the fastening portion therefore includes a suitable outer thread.

The protrusion which projects radially to the inside is provided inside of the hollow cylindrical bottom part. It serves to form the ventilation and aeration path as well as the emergency aeration path. Here, the conventional ventilation and aeration path extends via the central passage opening which is defined by the circumferential protrusion projecting to the inside. This central passage opening may be closed by the gas permeable membrane so that a gas, e.g. air, can flow through the membrane, though preferably, no pollution or humidity can enter into the housing and preferably, no liquid can exit the housing, either.

In order to continue to provide an emergency aeration path, the circumferential protrusion which projects to the inside includes the plurality of annularly arranged vents. Seen from the top, a structure of the inwards projecting circumferential protrusion results which consists of a radial outer and a radially inner ring, which are connected by a plurality of connecting webs. The radially inner ring defines the central passage opening and the radially outer ring is fixed to the inner wall of the hollow cylindrical bottom part. Thus, the plurality of annularly arranged vents is present between the connecting webs which connect the two rings.

The elastic sealing component is provided to seal the emergency aeration path during the regular operation of the pressure equalizing device. It is, however, not fastened adjacent to the central passage opening as known from the state of the art, but adjacent to the inner wall of the hollow cylindrical bottom part. For this purpose, the radially inwardly projecting circumferential protrusion comprises the first, preferably annular clamping structure, in particular the first annular groove, on the side which faces the second axial end. Thus, the first clamping structure is formed in or on the radially outer ring of the radially inwardly projecting protrusion.

A fixation of the elastic sealing component in axial direction takes place via the upper part which, in the assembled state of the pressure equalizing device, engages the connecting portion of the bottom part. Here, the basic shape of the connecting portion is annular, e.g. in the form of a circumferentially closed wall.

The upper part has the shape of a cylinder that is closed on one side. Thus, the upper part comprises a cylindrical wall which is closed on one side by means of a bottom. Here, the bottom can be configured such that it is completely closed or it can include a plurality of openings so as to further support a gas exchange between the inside of the pressure equalizing device and the outside.

For example, the radial inside of the cylindrical wall comprises an annular latching feature which, in the assembled state of the pressure equalizing device, engages corresponding latching features in the connecting portion of the bottom part. The annular latching feature is for example a circumferential groove on the inside of the cylindrical wall. That way, a fixation of upper part and bottom part to one another takes place in axial direction. In particular, the upper part and the lower part can no longer be separated from one another without being destroyed in axial direction.

In order to guarantee a flow path between the interior of the pressure equalizing device and the outside, the connecting portion of the bottom part comprises portions which, alternately, may project radially to the outside and are set back radially to the inside, when the connecting portion is formed as a circumferential wall. In the portions which project radially to the outside, there are also latching features on the radial outside. Therefore, in the assembled state of the pressure equalizing device, the upper part engages with the connecting portion on the second axial end of the bottom part, which may be by means of the latching features. The flow path from inside of the pressure equalizing device therefore extends between the inside of the cylindrical outer wall of the upper part and the portions which are set back radially to the inside in the connecting portion. Instead of the portions which are radially set back to the inside, breakthroughs, openings or recesses extending in an axial direction could also be provided in the connecting portion of the bottom part in order to provide the flow paths.

The second clamping structure for the elastic sealing component is provided radially inwards of the cylindrical wall of the upper part. It extends in an axial direction from the bottom of the upper part, which may be parallel to the cylindrical wall of the upper part, which may be arranged angularly and/or may comprise the second groove on its axial end that faces the bottom part. In the assembled state of the pressure equalizing device, the elastic sealing component is therefore clamped between the first clamping structure, which may be the first groove, and the second clamping structure, which may be the second groove.

A plurality of breakthroughs, openings or the like is provided in the second clamping structure so that the second clamping structure for the elastic sealing component does not block the flow path from inside of the pressure equalizing device to the outside or vice versa. Thus, the second clamping structure can also be comprised of a plurality of axial protrusions which are annularly arranged and comprise a second groove each. This will become apparent later in the detailed description of the embodiments.

As a result, in the assembled state of the pressure equalizing device, the elastic sealing component is therefore arranged or clamped with the fastening portion between the first and the second clamping structure. As the fastening portion is located adjacent to the inside of the hollow cylindrical bottom part, the sealing portion of the elastic sealing component extends radially to the inside in the direction of the central passage opening. The elastic sealing component has a corresponding opening in the center so that it does not cover the elastic passage opening. Thus, in general, the elastic sealing component is annularly shaped in the sealing portion when being viewed from the top. Due to this construction, when the pressure equalizing device is assembled, the elastic sealing component seals the plurality of vents adjacent to the central passage opening on the radially inner ring of the radially inwardly projecting, circumferential protrusion of the bottom part, without blocking the central passage opening, though.

Due to this construction, the common ventilation and aeration path extends centrally beyond the central passage opening and the gas permeable membrane, radially outwards through the second clamping structure of the bottom part and between the cylindrical wall of the upper part and through the portion of the wall, which is set back radially to the inside, in the connecting portion of the bottom portion to the outside. That way, a gas, e.g. air, can stream out from the inside of the housing to the outside and vice versa.

If the pressure inside of the housing increases unexpectedly high due to an extraordinary event, e.g. an accident, the increased air stream additionally deforms the elastic sealing component so that a gap between the elastic sealing component and the bottom part, which may be adjacent to the central passage opening, arises. Due to the specific arrangement of the elastic sealing component, only an aeration out of the housing via the elastic sealing component can be realized. A streaming of gas, e.g. air, from the outside to the inside, takes place exclusively via the gas permeable membrane and the central passage opening.

An advantage of the pressure equalizing device is that due to the clamping fixation of the elastic sealing component, a quick and easy assembly is possible, so that production becomes easier. Furthermore, the necessary power with which the elastic sealing component is retained, can be adjusted in an easy way. Furthermore, a compensation of manufacturing tolerances is possible, which additionally facilitates the manufacturing method.

A further advantage is that due to the construction of the pressure equalizing device as well as due to the connection between upper part and lower part, there is a special protection of the gas permeable membrane due to the openings to the side. For example, the penetration of humidity into the pressure equalizing device is impeded. This is particularly true in case the bottom of the upper part is configured completely closed.

In a further embodiment of the pressure equalizing device, the circumferential protrusion which projects radially to the inside is formed like a dome adjacent to the central passage opening in the direction of the second axial end, so that the gas permeable membrane and the elastic sealing component are arranged at different axial heights and the sealing portion of the elastic sealing component abuts the dome-like configuration at least partly. In other words and with reference to the presence of the radially inner ring and the radially outer ring, the radially inner ring and the radially outer ring are arranged at a distance to one another in axial direction.

Here, the radially inner ring is arranged more closely to the second axial end than the radially outer ring. In this context, it is to be considered, however, that the radially inner ring is arranged at an axial height which is below the second axial end that is defined by the wall of the connecting structure. Otherwise, in the assembled state, the bottom of the upper part would lie on the gas permeable membrane which is arranged on the central passage opening, and might possibly impede its proper functioning.

Furthermore, the radially outer ring and the connecting webs which define the plurality of vents could at least partly be arranged in the same plane. In this case, the shape of the dome arises for example due to a cone or a conical structure which conically projects in the direction of the second axial end, the cone or conical structure beginning on the radial inner side of the connecting webs and ending in a plateau, which is part of the radially inner ring and on which the gas permeable membrane is fastened. Adjacent to the connecting webs, the diameter of the conical cone or the conical structure is larger so that the diameter at the plateau is smaller.

In a first alternative, the outer circumference of the conical structure may continuously taper from the portion adjacent to the connecting webs towards the plateau. In this case, the circumferential elastic sealing component may form an annular seal radially inside to the dome or the conical structure, respectively, that is present coaxially in the bottom part. Due to the conical structure, the sealing which may be achieved by the elastic sealing component may be further improved and an influx of gas, e.g. air, into the inside of the housing through the plurality of vents may be prevented in an effective manner.

In a second alternative, the circumferential protrusion which may project radially to the inside comprises a step in the portion of the dome-like design, on which the sealing portion of the elastic sealing component at least partly lies. Thus, the outer circumference does not taper continuously but comprises a step. This can also effectively prevent the influx of gas, e.g. air, into the inside of the housing through the plurality of vents.

It is furthermore of advantage that in the central passage opening, there is a plurality of star-like arranged connecting webs. Due to the connecting webs in the central passage opening, i.e. inside of the radially inner ring of the protrusion which projects radially to the inside, a sudden load of the gas permeable membrane is reduced. Furthermore, the gas permeable membrane is protected against mechanical damage, misuse and the like already before the assembly of the assembled pressure equalizing device in the opening of the housing due to the arrangement between the upper part and the lower part.

The above-described effect of the connecting webs also applies to the connecting webs adjacent to or below the elastic sealing component which define the plurality of vents that are arranged annularly. Thus, a sudden load of both the gas permeable membrane and the elastic sealing component is effectively prevented in case of an extraordinary event.

In a further embodiment of the pressure equalizing device, the elastic sealing component includes a T-like configured fastening portion so that the sealing portion extends perpendicularly from the T-like fastening portion. It is this configuration which may be clamped specifically advantageously between the first clamping structure of the bottom part and the second clamping structure of the upper part. Furthermore, due to the T-like configuration, possible manufacturing tolerances of the upper part and the lower part can be compensated effectively. Furthermore, due to the T-like fastening portion, the elastic sealing component may be configured in a way that both of its sides may be used. Therefore, a supply in a correct positional arrangement is not necessary. This leads to an easier automatization during the production or the assembly of the pressure equalizing device.

Furthermore, according to a first alternative, the elastic sealing component includes: a sealing portion radially tapering to the inside and/or at least an annular protrusion axially projecting to the top or the bottom or at least an annular sealing lip axially projecting to the top or the bottom on a radial inner side of the sealing portion, which may be three annular protrusions or sealing lips and which may be three axially upwards projecting and three axially downwards projecting annular protrusions or sealing lips.

In the initial state, the elastic sealing component with the sealing portion that tapers radially to the inside constitutes an elastic sealing component which is configured straight and is manufactures symmetrically. Here, particularly the radial inner portion of the sealing portion, i.e. the portion with the smallest thickness, is deformed when being used in the pressure equalizing device in a way that it may abut the dome like portion. The increased pre-tension which is caused by that provides for a further improved sealing of the plurality of passage openings in normal operation.

Instead of the tapering configuration of the sealing portion or in addition to it, the elastic sealing component includes at least an annular protrusion or an annular sealing lip on at least one side, which may be three annular structures or protrusions or sealing lips, respectively, on each side. It is specifically this design with the at least one radial protrusion or the at least one annular sealing lip which leads to a further increase in the flexibility of the elastic sealing component and thus, the sealing particularly at the dome-like portion of the radially inwards projecting protrusion of the bottom part is additionally improved.

According to a second alternative, in cross section, the elastic sealing component may have a curvilinear course on the radial inside, which may be the course of a reversed U. The curvilinear course and thus in particular the reverse U shape is present adjacent to the radial inside of the sealing portion of the elastic sealing component. In this context, the term reverse U shape refers to a curvilinear course which extends from the radial inside in the direction of the radial outside in the assembled state of the elastic sealing component, first of all in the direction of the second axial end of the bottom part up to a vertex and back to the initial height, which may be to the height of the fastening portion. With this specific type of configuration, in particular in combination with a step that is present in the dome-like portion, as explained above, a further increased elastic pre-tension can be generated. Thus, the sealing behavior is further improved. A disadvantage is, however, that particularly this design must be supplied in a correct positional arrangement, which causes greater effort in terms of the production or assembly of the pressure equalizing device.

Advantageously, the upper part and/or the bottom part consist/s of a thermoplastic plastic material. That way, the pressure equalizing device can specifically be adapted to the temperature requirements and the necessary chemical resistance of the field of application. For example, the materials used for the upper part and/or the lower part are PP-GF, PBT, PA6 or PA66.

Furthermore, the pressure equalizing device may be configured in a way that the gas permeable membrane is fastened to the radially inwardly projecting circumferential protrusion adjacent to the passage opening by means of gluing, welding or integral overmolding. By that, the pressure equalizing device can be adapted to the respective application case and the used gas permeable membrane. By that, the gas permeable membrane can be a self-gluing equipped membrane foil for the ventilation and aeration of buildings. The pressure equalization or gas vent is carried out by means of a gluefree zone. Alternatively, the gas permeable membrane can be welded, too. Alternatively to these fastening methods, the gas permeable membrane can also be overmolded when the bottom part is manufactured, which will be explained in the following in connection with the manufacturing methods.

In a further advantageous embodiment, the elastic sealing component is made of silicone, rubber or a thermoplastic elastomer. Furthermore, on the radial outside, the pressure equalizing device may comprise a seal such as an O-ring, in particular adjacent to a radially outwards projecting flange between the fastening portion and the connecting portion. In both cases, i.e. both for the elastic sealing component as well as the seal, in particular the O-ring, the use of a material, e.g. an elastomer, is important, which resists the respective temperature requirements and has the necessary chemical resistance for the respective application field. Thus, the pressure equalizing device can be adapted further to the desired application case. With regard to the necessary hardness for the elastic sealing component and/or the seal, in particular the O ring, same can feature a similar hardness, e.g. in the range from 40 to 70 shore A. Particularly the design of the elastic sealing component with the curvilinear course may comprise a higher hardness of up to 80 shore A.

Finally, it is advantageous that the fastening portion of the pressure equalizing device is configured as a thread, a bayonet lock, a latching structure or a gluing structure. Due to this principally customizable fastening portion, the fastening of the pressure equalizing device in the housing can be implemented in a flexible manner and be adapted specifically to the required application case.

A housing, which may be a battery housing, with an opening has a pressure equalizing device that is arranged in the opening. As the housing comprises the pressure equalizing device, reference is made to the above statements in terms of the arising technical effects and advantages, in order to avoid repetitions.

A manufacturing method of a pressure equalizing device comprises the following steps: injecting molding a hollow cylindrical bottom part which on the radial outside at a first axial end comprises a fastening portion for the fastening to the housing and at a second axial end a connecting portion, with the hollow cylindrical bottom part comprising a circumferential protrusion projecting radially to the inside, defining a central passage opening and comprising on a side facing the second axial end a first, which may be an annular clamping structure, which may be a first annular groove, as well as between the central passage opening and the first clamping structure a plurality of annularly arranged vents, and injecting molding an upper part with a cylindrical wall and a bottom, with the upper part having a second clamping structure projecting from the bottom in axial direction, with the clamping structure which may be arranged annularly and/or comprising a second groove and which may extend in axial direction parallel to the cylindrical wall, fastening a gas permeable membrane on the bottom part, arranging an elastic sealing component with a fastening portion in the first clamping structure of the bottom part, with a sealing portion of the elastic sealing component extending radially to the inside in the direction of the central passage opening, and arranging the upper part on the bottom part so that the upper part engages with the connecting portion at the second axial end of the bottom part and the elastic sealing component is arranged with the fastening portion between the first clamping structure of the bottom part and the second clamping structure of the upper part, with the elastic sealing component sealing the plurality of vents in a way that a ventilation and aeration path extends via the central passage opening and the gas permeable membrane and an emergency aeration path extends via the plurality of vents and the elastic sealing component. The pressure equalizing device is produced with the manufacturing method. Therefore, reference is again made to the above explanations regarding the pressure equalizing device in terms of the arising technical effects and the associated advantages in order to avoid repetitions.

In a further embodiment of the manufacturing method, the step of fastening the gas permeable membrane on the bottom part comprises the overmolding of the gas permeable membrane during the injection molding of the bottom part. That way, the manufacturing method is further facilitated, as a separate step for fastening the gas permeable membrane at the bottom part can be omitted.

### 4. BRIEF DESCRIPTION OF THE DRAWINGS

In the following, the present disclosure will be described in detail with reference to the drawings. In the drawings, same reference signs refer to same components and/or elements. They show:

FIG. 1 an explosive view of an embodiment of a pressure equalizing device with a first embodiment of an elastic sealing component,

FIG. 2 a lateral view of an embodiment according to FIG. 1 in the assembled state,

FIG. 3 a sectional view of the embodiment according to FIG. 1 with the first embodiment of the elastic sealing component,

FIG. 4 a perspective view of the bottom part according to the embodiment of FIG. 1 from below,

FIG. 5 a top view on the bottom part according to FIG. 4,

FIG. 6 an enlarged perspective view of a part of the connecting portion of the bottom part according to FIG. 4,

FIG. 7 a perspective view of the upper part according to FIG. 1,

FIG. 8 a perspective view of the first embodiment of the elastic sealing component,

FIG. 9 a sectional view of the elastic sealing component according to FIG. 8,

FIG. 10 a sectional view of the pressure equalizing device with a second embodiment of the elastic sealing component,

FIG. 11 a perspective view of the second embodiment of the elastic sealing component,

FIG. 12 a sectional view of the elastic sealing component according to FIG. 11,

FIG. 13 a sectional view of the pressure equalizing device with a third embodiment of the elastic sealing component,

FIG. 14 a perspective view of the third embodiment of the elastic sealing component,

FIG. 15 a sectional view of the elastic sealing component according to FIG. 14, and

FIG. 16 a flow chart of an embodiment of the manufacturing method of the pressure equalizing device.

### 5. DETAILED DESCRIPTION

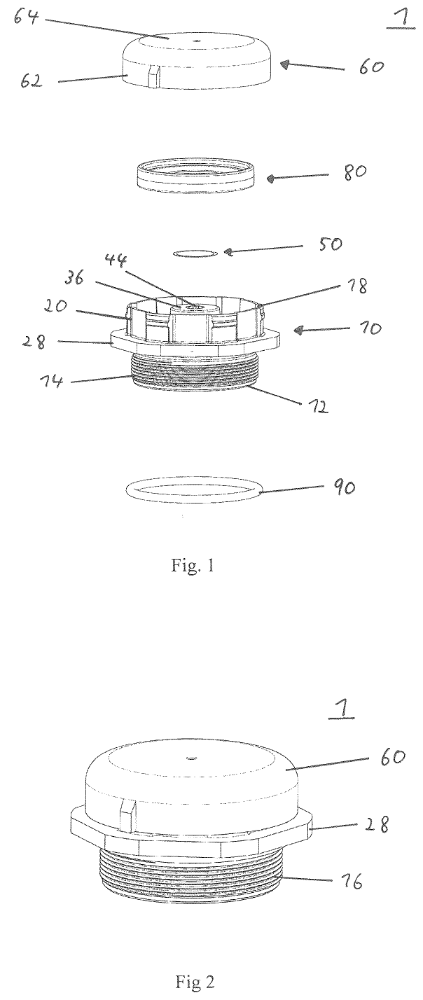

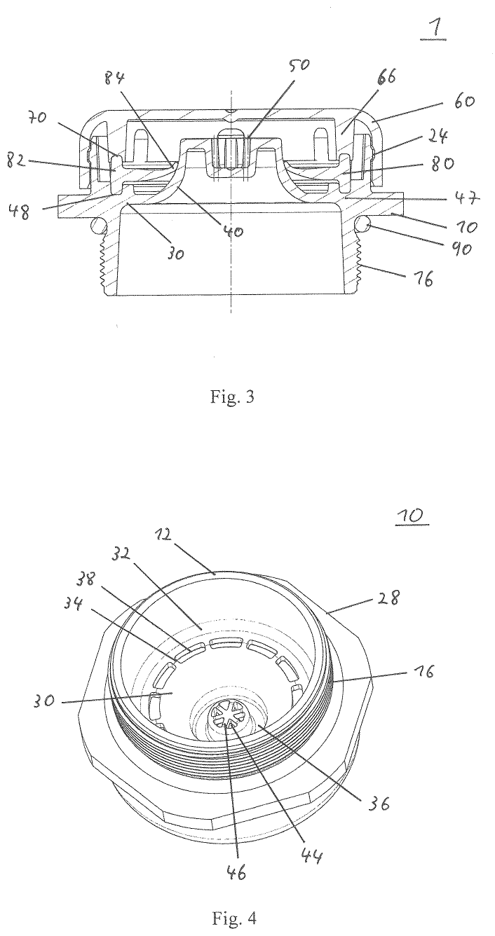

An embodiment of a pressure equalizing device 1 is shown in FIG. 1 in an exploded view, in FIG. 2 in an assembled state and in FIG. 3 in a sectional view. The pressure equalizing device 1 is used in a housing, e.g. a battery housing of a multi-power battery of an electric vehicle.

As can be seen particularly in FIG. 1, the pressure equalizing device 1 generally comprises a bottom part 10, a gas permeable membrane 50, an upper part 60 as well as an elastic sealing component 80. In the present embodiment, an O ring 90 as a seal for sealing in the course of the fastening in an opening of the housing (not shown) is furthermore provided.

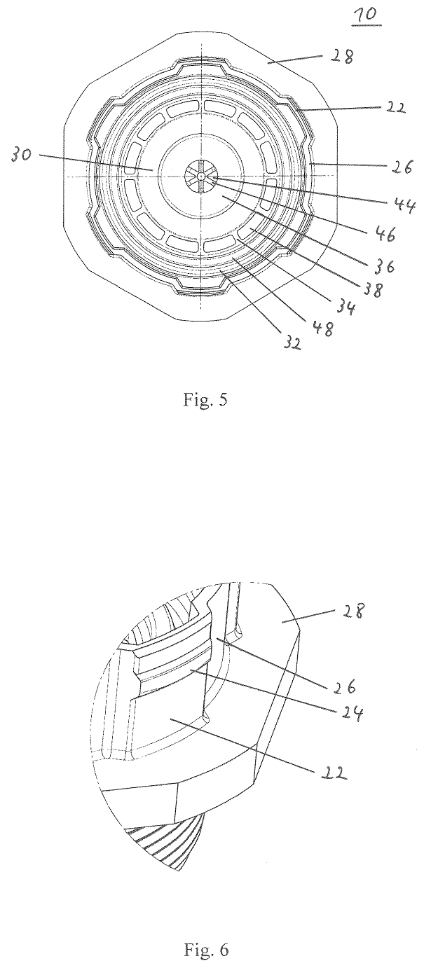

The individual parts of the pressure equalizing device 1 are discussed individually. Therefore, firstly, the bottom part 10 which is illustrated in FIGS. 4-6 is discussed.

The bottom part 10 is configured hollow-cylindrically and comprises at a first axial end 12 a fastening portion 14 for the fastening to a housing. In the present case, the fastening portion 14 includes an outer thread 16.

A connecting portion 20 is provided at a second axial end 18. Due to the hollow cylindrical configuration of the bottom part 10, the connecting portion 20 is formed by an annular wall in particular, wherein in the connection portion 20, portions 22 which project radially to the outside and portions 26 which are radially set back to the inside are alternately arranged. The radially outward projecting portions 22 additionally include a latching feature 24 which extends radially to the outside. The advantage of this assembly and the functionality are explained later in the discussion of the assembled pressure equalizing device 1.

For completion, it is pointed out that instead of the portions 26 which are radially set back to the inside, openings or breakthroughs can also be present at these locations. In this case, the connection portion 20 would be comprised of axial protrusions which constitute the radially outward projecting portion 22 and include the latching feature 24 which extends radially to the outside.

A flange 28 which projects radially to the outside is provided between the fastening portion 14 and the connecting portion 20. In the illustrated embodiment, the flange 28 is configured as a hexagon and has rounded corners. As a result, the flange 28 is a drive feature for screwing in the pressure equalizing device 1 by means of the outer thread 16 of the fastening portion 14 into the opening of the housing, which in this case comprises a corresponding inner thread.

In order to provide a corresponding sealing of the pressure equalizing device 1 in the opening of the housing, the O ring 90 is provided as a seal. It is, as can be seen in FIGS. 1 to 3, arranged in the fastening portion 14 adjacent to the flange 28.

Inside of the bottom part 10, a circumferential protrusion 30 which projects radially to the inside is furthermore provided. It serves for forming the ventilation and aeration path as well as the emergency aeration path. Both will be explained later in connection with the use of the pressure equalizing device 1. The circumferential protrusion 30 which projects radially to the inside is, when being viewed from top, comprised of a radially outer ring 32, connecting webs 34 which extend radially from the outer ring 32 to the inside, as well as a radially inner ring 36. Therefore, corresponding annularly arranged breakthroughs 38 are present between the connecting webs 34. They serve for the emergency aeration, which will also be explained later. Furthermore, there is a central passage opening 44 due to this structure, which is defined in particular by the radially inner ring 36 of the circumferential protrusion 30 which projects radially to the inside.

In the present embodiment, the radially inner ring 36 is configured like a dome with a conical structure 40. The conical structure 40 extends in a continuously tapering manner from a portion adjacent to the connecting webs 34 in the direction of a plateau. This can be seen particularly in connection with the sectional view in FIG. 3. Inside of the central passage opening 44, star-like arranged connecting webs 46 are furthermore provided. They are present axially in the direction of the first axial end 12 of the bottom part 10 with a distance to the plateau and connected with the plateau by means of a circumferential wall structure. The significance of these connecting webs 46 as well as the connecting webs 34 at the radially outer ring 32 is explained later.

The gas permeable membrane 50, which covers the central passage opening 44, is arranged on the plateau, i.e. on the radially inner ring 36. With regard to the axial height of the plateau, it should be observed that it is arranged below the second axial end 18, which is defined by the connecting portion 20. Otherwise, there is the risk that later in the assembled state of the upper part, the proper functionality of the gas permeable membrane 50 is impeded.

Finally, it should be emphasized that the radially outer ring 32 of the circumferential protrusion which projects radially to the inside includes a first annular clamping structure 47 in the form of a first annular groove 48, which is formed on the side which faces the second axial end 18.

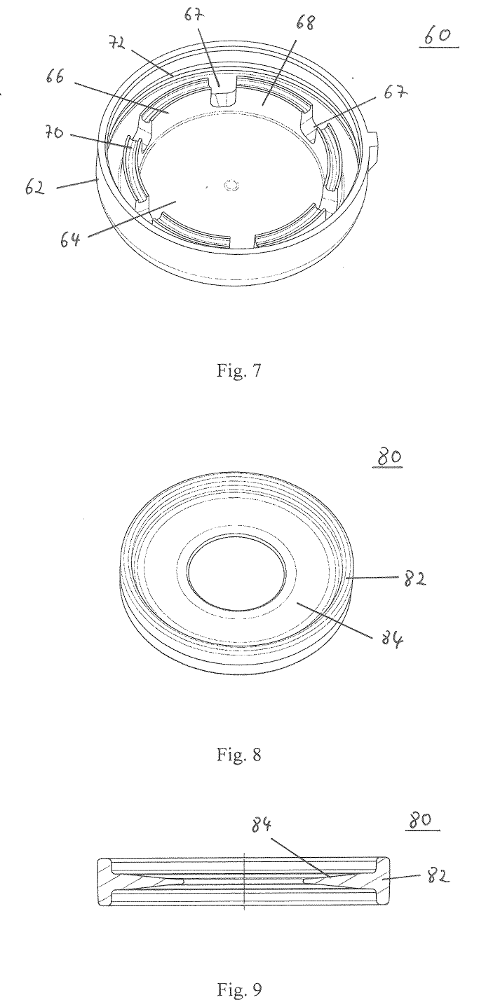

With reference to FIG. 7, the construction of the upper part 60 is now explained. It consists of a cylindrical wall 62 as well as a bottom 64. Furthermore, a second clamping structure 66 is provided, which projects in axial direction from the bottom 64 and is arranged annularly. The second clamping structure 66 includes a second groove 70 which also has an annular course. In the illustrated embodiment, the second clamping structure 66 furthermore extends in axial direction parallel to the cylindrical wall 62.

Furthermore, a circumferential latching feature 72 is provided on the radial inside of the cylindrical wall 62. In the assembled condition, it engages with the latching features 24 in the connecting portion 20 of the bottom part 10. For example, the latching feature 72 is a circumferential groove in the cylindrical wall 62. That way in particular, a position securing means in axial direction is provided, so that a destruction-free separating of upper part 60 and bottom part 10 can no longer be realized.

Again with reference to the upper part 60, the second clamping structure 66 is provided with a plurality of breakthroughs or recesses 67, resulting in a plurality of webs 68. Instead of the breakthroughs or recesses 67, openings such as for example bore holes in the second clamping structure 66 or the like could be provided. These breakthroughs, openings or recesses 67 are necessary to guarantee a flow path from inside of the pressure equalizing device 1 to the outside or vice versa. The same applies analogously for the portions 26 which are set back radially to the inside in the connecting portion 20 of the bottom part 10, as here, breakthroughs or recesses could be provided instead of the portion 26 which is set back radially to the inside, in order to secure the flow path out from and into the inside of the pressure equalizing device 1.

In the illustrated embodiment of the upper part 60, the bottom 64 has a closed configuration. Alternatively to that, one or a plurality of openings can be provided in the portion of the bottom 64 of the upper part 60 so as to further support the ventilation and aeration. Here, a disadvantage is, however, that humidity can enter more easily into the inside of the pressure equalizing device 1, compared to a bottom 64 with a closed configuration.

In FIGS. 8 and 9, a first embodiment of the elastic sealing component 80 is shown. It consists of a radial outer T-shaped fastening portion 82 as well as a sealing portion 84 extending radially to the inside. The elastic sealing component 80 has a central opening, so that in the assembled state of the pressure equalizing device 1, the sealing component 80 does not cover the central passage opening 44 and/or the gas permeable membrane 50 and hinders same in its function. The radial inner side of the sealing portion 84 therefore may abut the radially inner ring 36 and the conical structure 40 of the circumferential protrusion 30 which may project radially to the inside, thus sealing the vents 38.

An advantage of this embodiment of the elastic sealing component 80 is that it is configured symmetrically. Therefore, the correct positional orientation when assembling is not essential, rather, the elastic sealing component can be supplied in each orientation and fulfil its function.

It is obvious from FIG. 9 that the sealing portion 84 may taper from the radial outer end in the direction of the radial inner end. As in the assembled state, the elastic sealing component 80 may abut with the sealing portion 84 the dome-like or conical structure 40, as can be seen from FIG. 3 and as explained above. In particular, the radial inner end of the sealing portion 84 is bent in the direction of the second axial end 18. Thus, a corresponding pre-tensioning is generated so that the elastic sealing component 80 seals the vents 38 effectively.

When using the pressure equalizing device 1, the common ventilation and aeration path thus extends through the central passage opening 44 as well as the gas permeable membrane 50, radially to the outside through the second clamping structure 66 of the upper part 60 and between the cylindrical wall 62 of the upper part 60 and the portion 26 that is set back radially to the inside in the connecting portion 20 of the bottom part 10 to the outside. That way, a gas, e.g. air, can flow out from inside of the housing to the outside and vice versa. An advantage of this construction is that the gas permeable membrane 50 is specifically protected against humidity and pollution. Furthermore, the assembly is facilitated due to the low number of components as well as due to the symmetrically configured elastic sealing component 80. It should also be noted that due to the fastening portion 82 of the elastic sealing component 80, production-related tolerances between the upper part 60 and the bottom part 10 can be compensated better in comparison with the state of the art, so that production is facilitated further.

The connecting webs 34 and 46 serve for reducing a sudden load on the gas permeable membrane 50 and the elastic sealing component 80. Furthermore, due to the arrangement between the upper part and the bottom part, the gas permeable membrane 50 but also the elastic sealing component 80 are protected against mechanical damage, misuse and the like already before the arrangement of the assembled pressure equalizing device 1 in the opening of the housing.

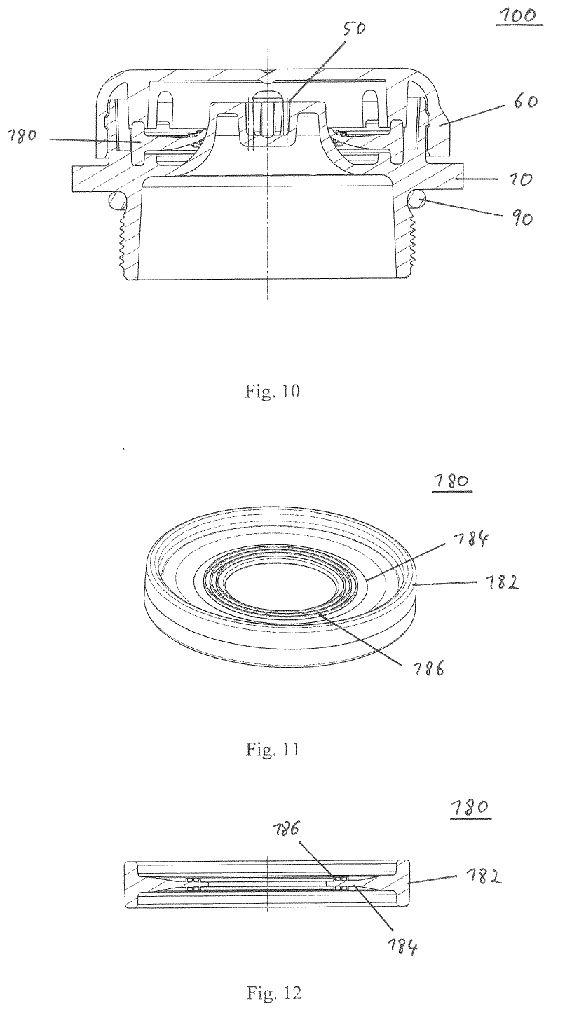

With reference to FIGS. 10-12, an alternative embodiment of the pressure equalizing device 100 is shown, in which another embodiment of an elastic sealing component 180 is particularly used. Apart from that, the construction of the pressure equalizing device 100 is identical with the first embodiment of the pressure equalizing device 1 with regard to the bottom part 10, the gas permeable membrane 50 and the upper part 60 as well as the O ring 90. Therefore, the functionality with respect to the first embodiment of the pressure equalizing device 1 is also the same.

In the second embodiment, the elastic sealing component 180 also comprises the fastening portion 182 which has a T shaped configuration. Likewise, the sealing portion 184 is provided which tapers from a radial outer end to a radial inner end, with an opening being provided centrally for the abutment to the dome like portion or the conical structure 40, respectively.

Unlike the previous embodiment, the sealing component 180 now however comprises three annular protrusions or sealing lips 186 on each side of the sealing portion 184 adjacent to the radially inner end. These annular protrusions or sealing lips 186 thus extend in axial direction from the sealing portion 184. The annular protrusions or sealing lips 186 increase the flexibility of the elastic sealing component 180 in the sealing portion 184 and improve the pre-tension at the conical structure 40 in particular. Thus, the sealing of vents 38 is further improved by the elastic sealing components 180.

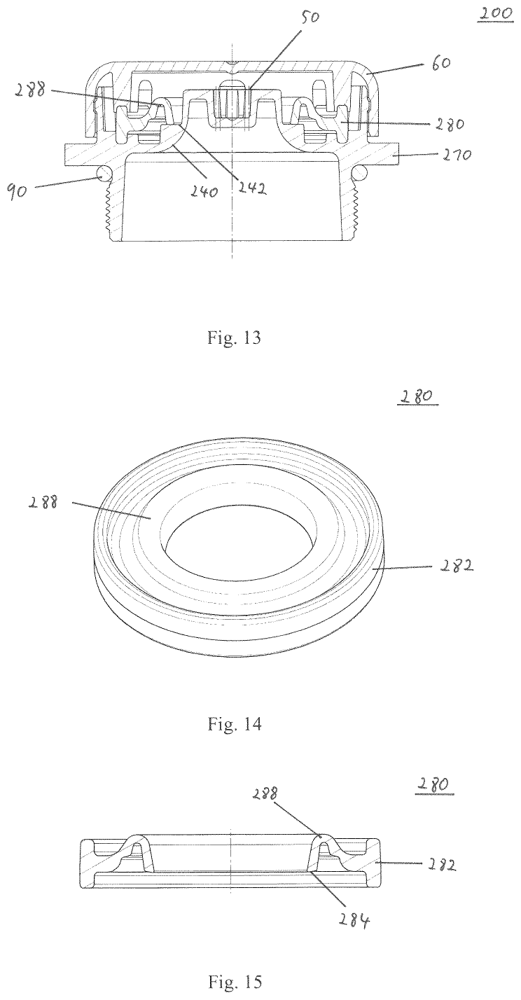

Another alternative of the pressure equalizing device 200 is shown in FIGS. 13-15. With respect to the basic construction, this configuration also corresponds to the previous embodiments so that hereinafter, particularly the differences are discussed. The basic course of the ventilation and aeration path as well as the emergency aeration path is the same as in the previous embodiments of the pressure equalizing device 1; 100.

In the design of the pressure equalizing device 200, a sealing portion 284 of an elastic sealing component 280 has a curvilinear portion 288. It is configured particularly like a reverse U. In this context, configured like a reverse U means that the course from the radial inner end of the sealing portion 284 increases in the direction of the second axial end 18 of the bottom part 10 up to a vertex and then decreases to the initial height.

A sealing with this configuration of the elastic sealing component 280 is particularly effective when the conical structure 240 is not formed continuously but includes a step 242 on which the radially inner end of the sealing portion 284 rests. That way, the pre-tensioning can be increased further and an effective sealing of the vents 38 can be achieved. A disadvantage of this configuration is, however, that the elastic sealing component 280 must be supplied in a correctly positioned manner due to the sealing portion 284, even if the fastening portion 282 is formed like a T analogously to the previous embodiments.

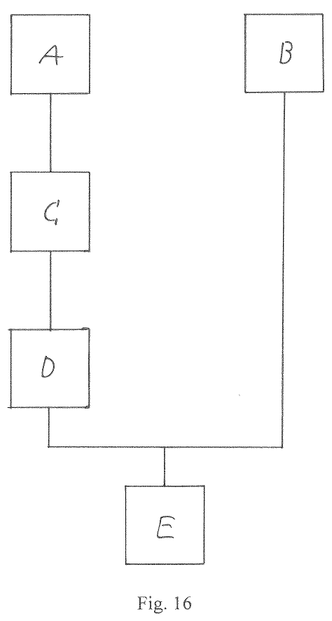

Finally, the manufacturing method of the pressure equalizing device 1; 100; 200 is explained based on the flow chart according to FIG. 16.

Thus, in a first step A, an injection molding of the hollow cylindrical bottom part 10; 210 takes place. As stated above, the upper part 10; 210 includes a fastening portion 14 radially outside at a first axial end 12 for the fastening to the housing and a connecting portion 20 at a second axial end 18. Furthermore, the hollow cylindrical bottom part 10; 210 includes a circumferential protrusion 30 projecting radially to the inside and defining a central passage opening 44. Furthermore, on a side facing the second axial end 18, the bottom part 10; 210 comprises a first, which may be an annular clamping structure 47, which may be a first annular groove 48, and between the central passage opening 44 and the first clamping structure 47 a plurality of annularly arranged vents 38. Advantageously, the fastening portion 14 is configured like a thread, bayonet lock, latching structure or gluing structure. Due to this principally customizable fastening portion 14, the fastening of the pressure equalizing device 1; 100; 200 is realizable flexibly in the housing and specifically adaptable to the desired application case.

In a second step B, an injection molding of the upper part 60 with the cylindrical wall 62 and the bottom 64 takes place, wherein the upper part 60 comprises a second clamping structure 66 projecting in axial direction from the bottom 64. It may be arranged annularly and comprises a second groove 70. The second clamping structure 66 may extend parallel in axial direction to the cylindrical wall 62.

A thermoplastic plastic material may be used as the material for the upper part 60 and/or the bottom part 10; 210. That way, the pressure equalizing device 1; 100; 200 can be adapted specifically to the temperature requirements and the necessary chemical resistance of the application field. The materials used for the upper part 60 and/or the bottom part 10; 210 are for example PP-GF, PBT, PA6 or PA66.

A fastening of the gas permeable membrane 50 on the bottom part 10; 210 takes place in step C. Here, the gas permeable membrane 50 is fastened in particular to the radially inner ring 36 of the protrusion 30, which projects radially to the inside, of the bottom part 10; 210. On the one hand, this can take place by means of gluing or welding. Thus, the gas permeable membrane 50 can be a self-adhesive membrane foil for the ventilation and aeration of housings. The pressure equalization or gas ventilation takes place via an adhesive free zone. Alternatively, the gas permeable membrane can also be welded. Furthermore, it is also implementable that the gas permeable membrane is overmolded when manufacturing the bottom part 10; 210. That way, the manufacturing method is further facilitated as a separate step for fastening the gas permeable membrane 50 to the bottom part 10; 210 and in particular to the radially inwardly projecting protrusion 30 can be omitted.

In step D, the elastic sealing component 80; 180; 280 is arranged with a fastening portion 82; 182; 282 in the first, which may be annular, clamping structure 47, which may be the first annular groove 48 of the bottom part 10; 210. In this context, the sealing portion 84; 184; 284 of the elastic sealing component 80; 180; 280 extends radially to the inside in the direction of the central passage opening 44.

An arranging of the upper part 60 on the bottom part 10 takes place in step E in a way that the upper part 60 engages with the connecting portion 20 at the second axial end 18 of the bottom part 10; 210 and the elastic sealing component 80; 180; 280 is arranged with the fastening portion 82; 182; 282 between the first clamping structure 47 of the bottom part 10 and the second clamping structure 66 of the upper part 60. By this, the elastic sealing component 80; 180; 280 seals the plurality of vents 38 in a way that a ventilation and aeration path extends beyond the central passage opening 44 and the gas permeable membrane 50 and an emergency ventilation path extends beyond the plurality of vents 38 and the elastic sealing component 80; 180; 280.

The elastic sealing component 80; 180; 280 may consist of silicone, rubber or a thermoplastic elastomer. Furthermore, the pressure equalizing device 1; 100; 200 comprises a sealing such as an O ring on the radial outside, which may be adjacent to a radially outward projecting flange 28 between the fastening portion 14 and the connecting portion 20.

In both cases, i.e. both for the elastic sealing component 80; 180; 280 as well as for the sealing, in particular the O ring 90, the use of a material, e.g. an elastomer, is important which resists the respective temperature requirements and has the desired chemical resistance for the respective field of use. Thus, the pressure equalizing device 1; 100; 200 can be adapted further to the desired application case. With regard to the necessary hardness for the elastic sealing component 80; 180; 280 and/or the sealing, in particular the O ring 90, they can have a similar hardness, e.g. in the range from 40 and 70 shore A. In particular, the configuration of the elastic sealing component 280 with the curvilinear course 288 may have a higher hardness of up to 80 shore A.

1. A pressure equalizing device for a housing, with the pressure equalizing device comprising:
a. a hollow cylindrical bottom part which radially outside at a first axial end includes a fastening portion for being fastened to the housing, and at a second axial end a connecting portion,
b. an upper part having a cylindrical wall and a bottom and engaging the connecting portion at the second axial end of the bottom part, wherein
c. the hollow cylindrical bottom part has a circumferential protrusion projecting radially to the inside and defining a central passage opening, and on a side facing the second axial end a first, clamping structure as well as a plurality of vents that are arranged annularly between the central passage opening and the first clamping structure, and
d. the upper part comprises a second clamping structure projecting in axial direction from the bottom, wherein
e. a gas permeable membrane covers the central passage opening and
f. an elastic sealing component is arranged with a fastening portion between the first clamping structure of the bottom part and the second clamping structure of the upper part and extends with a sealing portion radially to the inside in the direction of the central passage opening and seals the plurality of vents, so that
g. a ventilation and aeration path extends via the central passage opening and the gas permeable membrane and an emergency aeration path extends via the plurality of vents and the elastic sealing component.

2. The pressure equalizing device according to claim 1 with the circumferential protrusion which projects radially to the inside is formed like a dome adjacent to the central passage opening in the direction of the second axial end, so that the gas permeable membrane and the elastic sealing component are arranged at different axial heights and the sealing portion of the elastic sealing component abuts the dome-like configuration at least partly.

3. The pressure equalizing device according to claim 2, with the circumferential protrusion which projects radially to the inside comprising a step in the portion of the dome-like design, on which the sealing portion of the elastic sealing component at least partly lies.

4. The pressure equalizing device according to claim 2, which comprises a plurality of star-like arranged connecting webs in the central passage opening.

5. The pressure equalizing device according to claim 1, with the elastic sealing component having a T-like configured fastening portion so that the sealing portion extends perpendicularly from the T-like fastening portion.

6. The pressure equalizing device according to claim 1, with the elastic sealing component including:
a. a sealing portion radially tapering to the inside and/or
b. at least an annular protrusion axially projecting to the top or the bottom on a radial inner side of the sealing portion.

7. The pressure equalizing device according to claim 1, with the elastic sealing component having a curvilinear course in cross-section on the radial inside.

8. The pressure equalizing device according to claim 1, with the upper part and/or the bottom part consisting of a thermoplastic plastic material.

9. The pressure equalizing device according to claim 1, with the gas permeable membrane being fastened to the radially inwardly projecting circumferential protrusion adjacent to the passage opening by means of gluing, welding or integral overmolding.

10. The pressure equalizing device according to claim 1, with the elastic sealing component being made of silicone, rubber or a thermoplastic elastomer.

11. The pressure equalizing device according to claim 1, furthermore having, on the radial outside, a seal.

12. The pressure equalizing device according to claim 1, with the fastening portion being configured as a thread, a bayonet lock, a latching structure or a gluing structure.

13. A housing, having an opening in which a pressure equalizing device according to claim 1 is arranged.

14. A manufacturing method of a pressure equalizing device according to claim 1, comprising the following steps:
a. injecting molding a hollow cylindrical bottom part which on the radial outside comprises at a first axial end a fastening portion for the fastening to the housing and at a second axial end a connecting portion, with the hollow cylindrical bottom part comprising a circumferential protrusion projecting radially to the inside, defining a central passage opening and comprising on a side facing the second axial end a first clamping structure as well as between the central passage opening and the first clamping structure a plurality of annularly arranged vents, and
b. injecting molding an upper part with a cylindrical wall and a bottom, with the upper part having a second clamping structure projecting from the bottom in axial direction.
c. fastening gas permeable membrane on the bottom part,
d. arranging an elastic sealing component with a fastening portion in the first clamping structure of the bottom part, with a sealing portion of the elastic sealing component extending radially to the inside in the direction of the central passage opening, and
e. arranging the upper part on the bottom part so that the upper part engages with the connecting portion at the second axial end of the bottom part and the elastic sealing component is arranged with the fastening portion between the first clamping structure of the bottom part and the second clamping structure of the upper part, with the elastic sealing component sealing the plurality of vents in a way that a ventilation and aeration path extends via the central passage opening and the gas permeable membrane and an emergency aeration path extends via the plurality of vents and the elastic sealing component.

15. The manufacturing method according to claim 14, with the step of the fastening of the gas permeable membrane on the bottom part comprising the overmolding of the gas permeable membrane during the injection molding of the bottom part.
